(19) United States
(12) Patent Application Publication
(10) Pub. No.: US 2021/0312482 A1
(43) Pub. Date: Oct. 7, 2021

(54) COMPOSITION RATIO CORRECTION DEVICE, COMPOSITION RATIO CORRECTION METHOD, AND COMPOSITION RATIO CORRECTION PROGRAM

(71) Applicant: NEC Corporation, Minato-ku, TOKYO (JP)

(72) Inventors: Yuuki KUBOTA, Tokyo (JP); Takayuki NAKANO, Tokyo (JP); Ryo TAKATA, Tokyo (JP)

(73) Assignee: NEC Corporation, Minato-ku, TOKYO (JP)

(21) Appl. No.: 17/266,737

(22) PCT Filed: Apr. 10, 2019
(86) PCT No.: PCT/JP2019/015590

§ 371 Date: Feb. 8, 2021

(30) Foreign Application Priority Data
Aug. 10, 2018 (JP) 2018-151251

(51) Int. Cl. G06Q 30/02; G06Q 10/08

(52) U.S. Cl. CPC G06Q 30/0202; G06Q 10/087; G06Q 30/0201

(57) ABSTRACT

The component ratio calculation unit 81 calculates a single product sales composition ratio that is a ratio of a sales quantity of each target product to total sales, in a predetermined aggregation period, in a product category to which the target product belongs. The sales prospect quantity calculation unit 82 calculates a sales prospect quantity of the target product during a time period when the target product was out of stock, based on the total sales in the product category to which the target product belongs during the time period when the target product was out of stock and the calculated ratio.

### TECHNICAL FIELD

The present invention relates to a composition ratio correction device, a composition ratio correction method, and a composition ratio correction program for correcting a predicted sales composition ratio of products or services.

### BACKGROUND ART

Demand predictions are made for each product and service in various industries. In such cases, there may be other products with similar properties and characteristics to the product to be predicted. The product to be predicted and other products similar to this product may be substitutable for each other, and one of them may be selected. For example, even if no beverage of type A is present in a store, it is quite possible that a beverage of type B may be purchased instead.

A method for making predictions based on the relevance of such products is described in the patent literature 1. The method described in patent literature 1 focuses on an object for predicting demand (a first object), an object that is in a mutually substitutable relationship with the first object (a second object), and an object that includes the first and second objects (a third object). Specifically, in the method described in patent literature 1, the demand is predicted based on a result of the predicting demand for the third object and a ratio of the first object in objects including the second object.

In order to further improve predicting accuracy, opportunity loss may also be taken into account in past sales performance. As in the example above, even if no beverage of type A exists in a store, some customers may purchase a beverage of type B, as in the example above. Therefore, the absence of a certain target product does not simply mean that there is an opportunity loss for the projected volume of the target product.

An example of a method for calculating such an opportunity loss is described in patent literature 2. In the method described in the patent literature 2, the opportunity loss of the target product set for a period of time is calculated by predicting quantity of demands with missing products according to the pattern of missing products.

### CITATION LIST

### Patent Literature

PTL1: WO 2016/120918
PTL2: WO 2018/008303

### SUMMARY OF INVENTION

### Technical Problem

When predicting demand based on a ratio, as in the method described in the patent literature 1, if a certain period of time exists in which an appropriate quantity of sales of a product cannot be obtained due to a shortage of products, quantity of demands for that product may be calculated low.

In addition, when using the method described in the patent literature 2, it is possible to calculate the opportunity loss of a target product set, but it does not take into account the opportunity loss of individual products in the event of a shortage. Accordingly, it is preferable to be able to predict the future demand for each product with high accuracy even if the shortage of the individual products to be predicted has occurred in the past.

Therefore, it is an exemplary object of the present invention to provide a composition ratio correction device, a composition ratio correction method, and a composition ratio correction program capable of appropriately correcting an assumed sales composition ratio among similar products, even when a shortage occurs in an individual product to be predicted.

### Solution to Problem

The composition ratio correction device according to the present invention includes: a component ratio calculation unit which calculates a single product sales composition ratio that is a ratio of a sales quantity of each target product to total sales, in a predetermined aggregation period, in a product category to which the target product belongs; and a sales prospect quantity calculation unit which calculates a sales prospect quantity of the target product during a time period when the target product was out of stock, based on the total sales in the product category to which the target product belongs during the time period when the target product was out of stock and the calculated ratio, wherein the component ratio calculation unit corrects the single product sales composition ratio for each target product using a value which is calculated by adding the calculated sales prospect quantity to the sales quantity of the target product.

The composition ratio correction method according to the present invention includes: calculating a single product sales composition ratio that is a ratio of a sales quantity of each target product to total sales in a product category to which the target product belongs; calculating a sales prospect quantity of the target product during a time period when the target product was out of stock, based on the total sales in the product category to which the target product belongs during the time period when the target product was out of stock and the calculated ratio; and correcting the single product sales composition ratio for each target product using a value which is calculated by adding the calculated sales prospect quantity to the sales quantity of the target product.

The composition ratio correction program according to the present invention causes a computer to perform: a component ratio calculation process of calculating a single product sales composition ratio that is a ratio of a sales quantity of each target product to total sales, in a predetermined aggregation period, in a product category to which the target product belongs; and a sales prospect quantity calculation process of calculating a sales prospect quantity of the target product during a time period when the target product was out of stock, based on the total sales in the product category to which the target product belongs during the time period when the target product was out of stock and the calculated ratio, wherein in the component ratio calculation process, causing the computer to perform correcting the single product sales composition ratio for each target product using a value which is calculated by adding the calculated sales prospect quantity to the sales quantity of the target product.

### Advantageous Effects of Invention

According to the present invention, the assumed sales composition ratio among similar products can be appropriately corrected even when there is a shortage in the individual products to be predicted.

### BRIEF DESCRIPTION OF DRAWINGS

FIG. 1 It is a block diagram illustrating an example configuration of an exemplary embodiment of a composition ratio correction device according to the present invention.

FIG. 2 It is an explanatory diagram showing an example of past sales quantities of several target products.

FIG. 3 It is an explanatory diagram illustrating an example of a process for calculating a single product sales composition ratio.

FIG. 4 It is an explanatory diagram showing another example of process for calculating a single product sales composition ratio.

FIG. 5 It is an explanatory diagram illustrating an example of a process for calculating total sales of a product in a product category.

FIG. 6 It is an explanatory diagram illustrating an example of a process for updating a single product sales composition ratio.

FIG. 7 It is a flowchart illustrating an example of operation of the composition ratio correction device.

FIG. 8 It is a flowchart showing another example of operation of the composition ratio correction device.

FIG. 9 It is a block diagram illustrating a summarized configuration of a composition ratio correction device according to the present invention.

FIG. 10 It is a schematic block diagram of a configuration of a computer in accordance with at least one exemplary embodiment.

### DESCRIPTION OF EMBODIMENTS

Hereinafter, exemplary embodiments of the present invention will be described with reference to the drawings.

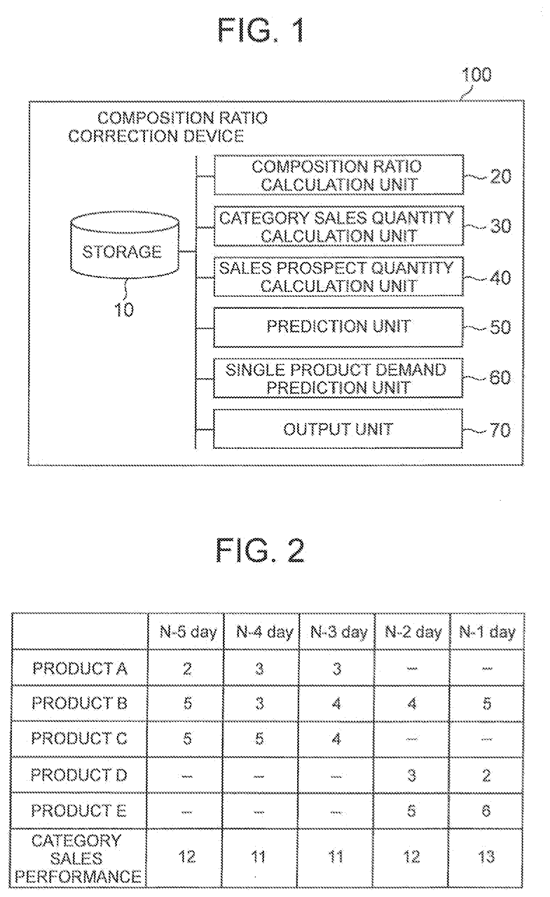

FIG. 1 is a block diagram illustrating an example configuration of an exemplary embodiment of a composition ratio correction device according to the present invention. The sales composition ratio correction device 100 in this exemplary embodiment comprises a storage 10, a composition ratio calculation unit 20, a category sales quantity calculation unit 30, a sales prospect quantity calculation unit 40, a prediction unit 50, a single product demand quantity prediction unit 60, and an output unit 70.

The storage 10 stores various information used to correct the sales composition ratio. Specifically, the storage 10 stores past sales quantities of respective target products for each predetermined unit of aggregation (hereinafter referred to as the aggregation period). The aggregation period is a unit for aggregating the sales performance of the products. The aggregation period may be the same as or different from a cover period representing a period of time from one delivery point to the next delivery point. For example, if the aggregation period is one day, and multiple deliveries are made on a daily basis, the aggregation period is the period of time that accumulates the multiple cover periods.

Further, the storage 10 stores total sales in a product category unit to which each target product belongs for each aggregation period. The product categories are classifications each representing a group of similar products and are predetermined for respective products based on a characteristic of a product, a sales style of a product, and the like. Instead of storing total sales in each product category, the storage 10 may store only the relationship between a sales quantity of each target product and a product category to which each target product belongs, and total sales in each product category may be aggregated separately. The product category to which each target product belongs is predetermined by the user or others.

FIG. 2 is an explanatory diagram showing an example of past sales quantities of several target products. In the example shown in FIG. 2, it is denoted that a sales quantity of each product, whose unit of aggregation is one day, is stored for the past five days. Further, in the example shown in FIG. 2, it is assumed that products A to E belong to a certain product category. For example, if the product category is “rice ball”, products A to E correspond to individual products such as, for example, “rice ball including salmon”, “rice ball including plum”, “rice ball including tuna and mayonnaise (tuna mayo)”, “red rice ball”, “rice ball including kelp” and so on.

The each past sales quantity illustrated in FIG. 2 as an example is a number of sales in the state where out-of-stock of the target product is not taken into account. In this exemplary embodiment, even if the desired target product is out of stock, the customer is assumed to buy another target product belonging to the same product category, and total sales in each product category within the aggregation period shall remain the same. Specifically, for example, a customer who wants to buy a rice ball is expected to buy another rice ball in the same product category, even if the desired product is out of stock. In other words, in this exemplary embodiment, the total sales in each product category is the same regardless of whether the product is out of stock or not.

In the example shown in FIG. 2, for example, even if a product A is out of stock on the N−5 day, the total sales in the product category (category sales performance) on the N−5 day remain the same as 12 as a result of the customer buying an alternative product (product B or product C).

The storage 10 may store a past sales quantity of each product and total sales in each product category on a time basis. Further, the storage 10 may be linked to a system (not shown) that manages a stock quantity, and may explicitly store the time at which the target product is out of stock. Otherwise, the storage 10 may store the time at which the product are scheduled to be delivered (hereinafter referred to as “scheduled delivery time”) in a transport basis, and may also store the period from one delivery to the next (a cover time period).

Normally, the product is replenished at the start of the cover time period, which means that the product is in stock and the product is no longer missing. On the other hand, if the product is out of stock before the next delivery, the product will continue to be out of stock until the end of the cover period. Therefore, the time from the time when the product is out of stock to the scheduled delivery time is equivalent to the out-of-stock time.

The composition ratio calculation unit 20 calculates a ratio of sales quantities of respective target products to total sales in a predetermined aggregation period of the product category to which the target product belongs (hereinafter referred to as the single product sales composition ratio). For example, when the aggregation period is in the unit of a day, the composition ratio calculation unit 20 calculates the single product sales composition ratio on a daily basis.

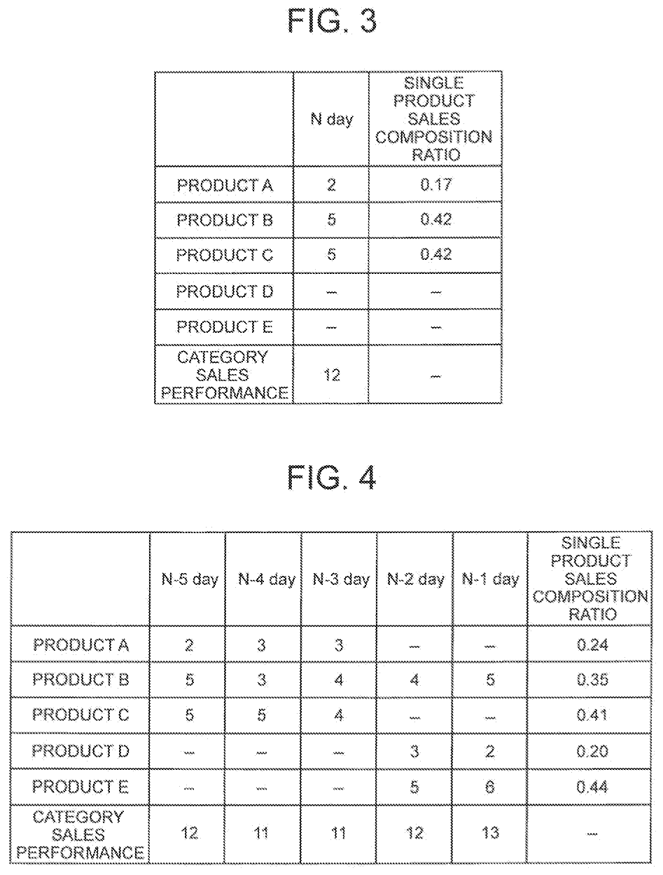

FIG. 3 is an explanatory diagram showing an example of a process for calculating the single product sales composition ratio. In the example shown in FIG. 3, suppose that each sales quantity of product A, product B and product C belonging to the same product category on a certain day is 2, 5 and 5, respectively. In this case, the composition ratio calculation unit 20 calculates the single product sales composition ratio of each product to total sales in the entire product category as 0.17, 0.42 and 0.42, respectively.

When the sales quantity is obtained over a plurality of aggregation periods, the composition ratio calculation unit 20 may calculate an average of the single product sales composition ratio for each target product for each aggregation period. The target period for calculating the average may be determined in advance.

FIG. 4 is an illustration of an example of a process for calculating the single product sales composition ratio based on the sales quantities illustrated in FIG. 2. For example, if the period of time for which an average is to be calculated is five days, the composition ratio calculation unit 20 may calculate the average of the ratios calculated between N−5 day and N−1 day as illustrated in FIG. 2. For example, for product A, the sales quantity on N−5 day is 2 and the total sales in the product category is 12. Therefore, the composition ratio calculation unit 20 calculates a ratio for N−5 day as 2/12. Similarly, the composition ratio calculation unit 20 calculates a ratio of N−4 day as 3/11 and a ratio of N−3 day as 3/11. The composition ratio calculation unit 20 then calculates the single product sales composition ratio for product A as (2/12+3/11+3/11)/3 approximately equal to 0.24. The same is true for the other products B to E.

The single product sales composition ratio illustrated in FIG. 3 or FIG. 4 is a ratio that does not take into account the occurrence of out-of-stock. Therefore, the composition ratio calculation unit 20 calculates (updates) the single product sales composition ratio using the value corrected in the process described below. The method of calculating the single product sales composition ratio will be described later.

The method of selecting the target product for calculating the single product sales composition ratio can be optionally selected. The composition ratio calculation unit 20 may calculate the single product sales composition ratio by using a product pre-selected by a user or the like as the target product. For example, a standard product can be said to be a product that is likely to be selected as a substitute product even when other products in the same product category are out of stock. It is desirable for such products to avoid running out of stock as much as possible, while minimizing disposal losses, even when other products in the same product category are no longer available. Therefore, such a standard product may be selected in advance as the target product.

The target product may be selected based on past sales results. For example, the composition ratio calculation unit 20 may select a product that has achieved rankings equal to or higher than a predetermined ranking (e.g., one of the top five rankings/day, etc.) for a sales quantity during a predetermined period (e.g., the past four weeks, etc.) over a predetermined number of times (e.g., more than 15 days, etc.) as the target product for calculating the single product sales composition ratio. For example, since the change of quantity of demands for a standard product is small, the accuracy of the predict can be improved by selecting it as a target product. It is preferable not to take into account the shortage time for seasonal products and other products for which the change in the number of predictions is large, since the predict accuracy may be reduced.

The category sales quantity calculation unit 30 calculates, for each aggregation period, total sales in the product category to which the target product belongs during the time period when the target product was out of stock. Specifically, the category sales quantity calculation unit 30 obtains from the storage 10 the total sales, corresponding to the time period when the target product was out of stock, in the product category to which the target product belongs, and aggregates the total sales obtained for each aggregation period. For example, if the target product is out of stock multiple times in a day, the category sales quantity calculation unit 30 adds the total sales in all the time periods when the target product was out of stock.

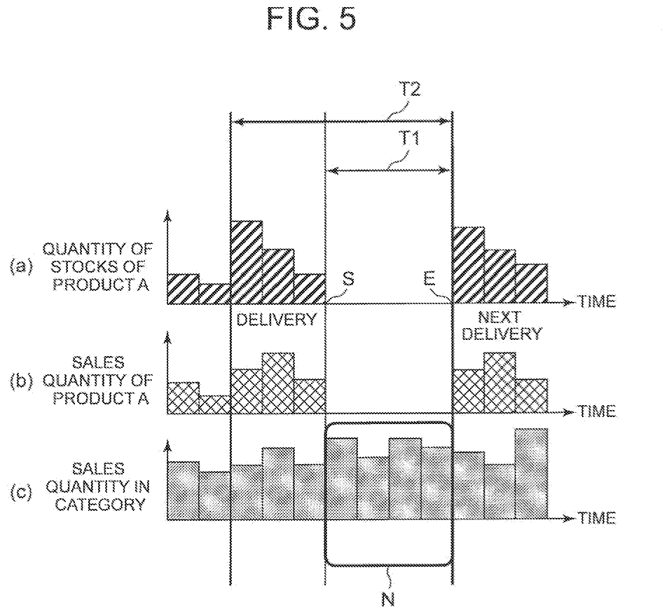

FIG. 5 is an explanatory diagram illustrating an example of a process for calculating total sales of the product in the product category to which the target product belongs when the target product is out of stock. For product A, suppose that the number of stocks decreases as illustrated in FIG. 5(b) due to the sales quantity as illustrated in FIG. 5(b), and the product is out of stock during the out-of-stock period T1. In this case, the category sales quantity calculation unit 30 obtains total sales N by adding in the product category for the out-of-stock period T1, as illustrated in FIG. 5(c).

The start time S of the out-of-stock period T1 illustrated in FIG. 5 can be obtained, for example, as a time of the out-of-stock occurrence, and the end time E of the out-of-stock period T2 can be obtained, for example, from a scheduled delivery time.

The sales prospect quantity calculation unit 40 calculates a sales prospect quantity during the time period when the target product was out of stock, based on total sales in the product category during the time period when the product was out of stock calculated by the calculation unit 30 and the single product sales composition ratio calculated by the composition ratio calculation unit 20. Specifically, the sales prospect quantity calculation unit 40 calculates sales prospect quantity of the target product during the time period when the target product was out of stock, based on the formula 1 illustrated below.

Sales Prospect Quantity=Single Product Sales Composition Ratio×Total Sales Quantity in the Product Category during the Time Period when the Item was Out of Stock (Formula 1)

For example, suppose that the cover period T2 as illustrated in FIG. 5 is 10:00-16:00 for a second transport, and the time of out-of-stock occurrence is 12:30. In this case, the sales prospect quantity is calculated as the single product sales composition ratio of product A from 10:00 to 12:00 x total sales in the product category from 12:00 (12:30 rounded down) to 16:00.

More specifically, suppose that the total sales in the product category during the out-of-stock period T1, as illustrated in FIG. 5, is 12. Further, suppose that the single product sales composition ratio (0.24) as illustrated in FIG. 4 has been calculated for Product A. In this case, the sales prospect quantity calculation unit 40 calculates sales prospect quantity to be 2.88 (approximately equal to 3) by multiplying the single product sales composition ratio (0.24) of product A by the total sales in the product category to which product A belongs (12). The treatment of decimal points can be predetermined by rounding up, rounding down, or rounding off.

Thereafter, the composition ratio calculation unit 20 corrects the single product sales composition ratio by considering the sales prospect quantity. Specifically, the composition ratio calculation unit 20 adds the sales prospect quantity calculated by the sales prospect quantity calculation unit 40 to the actual sales quantity of the target product. The composition ratio calculation unit 20 then calculates the ratio of the sales quantity of each target product to the total sales in a predetermined aggregation period of the product category to which the target product belongs (i.e., the single product sales composition ratio), in a similar manner to the process described above. Further, the composition ratio calculation unit 20 may calculate an average of the single product sales composition ratio for each target product in each aggregation period.

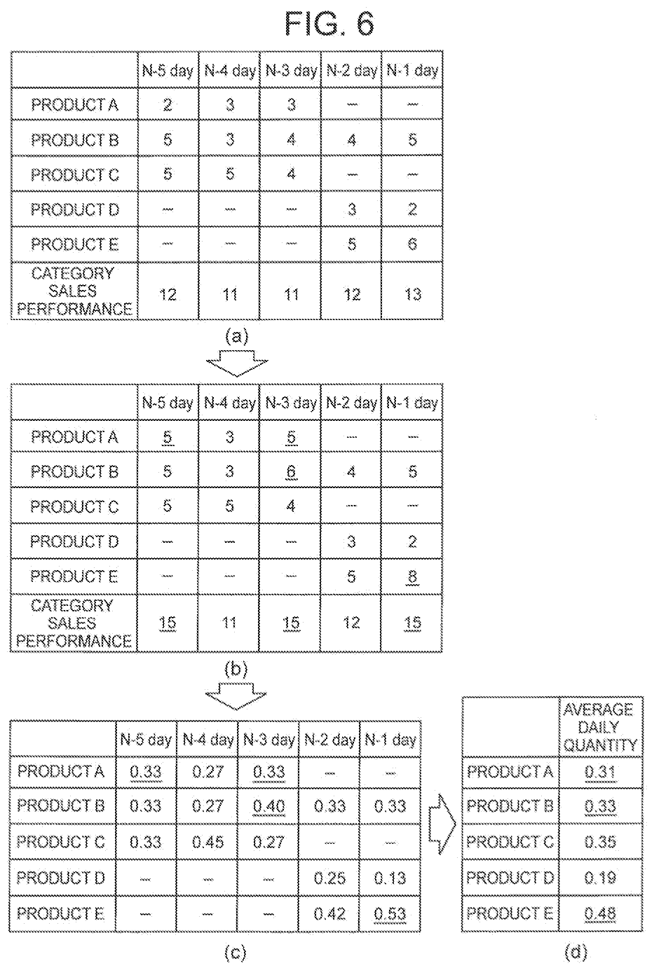

FIG. 6 is an explanatory diagram illustrating an example of the process for updating the single product sales composition ratio. FIG. 6(a) shows the past sales quantity of each target product illustrated in FIG. 2. For example, suppose that for product A, the sales prospect quantity on N−5 day is calculated to be 3 and the sales prospect quantity on N−3 day is calculated to be 2. Likewise, suppose that the sales prospect quantity on N−3 day for product B is calculated to be 2, and the sales prospect quantity on N−1 day for product E is calculated to be 2. In this case, the composition ratio calculation unit 20 adds the calculated sales prospect quantity of each target product to the sales quantity of the each target product (refer to FIG. 6(b)).

The composition ratio calculation unit 20 calculates a ratio of the sales prospect quantity of each target product (i.e., the single product sales composition ratio) for each aggregate period using the sales quantity to which the sales prospect quantity is added. For example, for product A, since the sales prospect quantity on N−5 day is calculated as 3, the sales prospect quantity is calculated as 2+3=5. In this case, total sales on N−5 day is also calculated to be 12+3=15. Therefore, the composition ratio calculation unit 20 corrects the single product sales composition ratio for product A to 5/15=0.33. The same is true for other days and products (refer to FIG. 6(c)).

The composition ratio calculation unit 20 may calculate the average of the single product sales composition ratios for each target product for each aggregation period. In the example shown in FIG. 6, for example, for product A, the single product sales composition ratio on N−5 day is corrected to 0.33, and the single product sales composition ratio for N−3 day is corrected to 0.33. Therefore, the composition ratio calculation unit 20 may calculate an average of 3-days single product sales composition ratios as (0.33+0.27+0.33)/3=0.31. The same is true for the other products (refer to FIG. 6(d)).

The above-mentioned process shows, for example, that the single product sales composition ratio has increased from the value (0.24) illustrated in FIG. 4 to 0.31 as a result of the addition of sales prospect quantity for product A illustrated in FIG. 6. Thus, since the composition ratio calculation unit 20 calculates the single product sales composition ratio using addition of the sales prospect quantity, even in the event of a shortage of products to be predicted, the number of products that may be sold at the time of the shortage is taken into account, thus making it possible to predict the demand for each product with high accuracy.

In addition, in this exemplary embodiment, since the single product sales composition ratio of a product that is out of stock is updated, an extreme increase or decrease in the number of product orders for the product that is out of stock can be prevented.

The prediction unit 50 predicts the quantity of demands for each product category for each aggregation period. For example, if the aggregation period is one day, the prediction unit 50 predicts the quantity of demands for each product category on a daily basis. The method by which the prediction unit 50 makes the predict can be optionally selected, and a general method may be used.

The single product demand quantity prediction unit 60 predicts a single product demand quantity of the target product included in the product category based on the predicted result of the quantity of demands for each product category in the aggregation period predicted by the prediction unit 50 and the corrected (i.e., calculated by adding the sales prospect quantity) single product sales composition ratio. Here, the single product demand quantity is predicted for an individual product, and is calculated by multiplying the predicted result of the quantity of demands for each product category by the single product sales composition ratio of each target product.

The output unit 70 outputs the single product demand quantity of the target product calculated by the single product demand prediction unit 60. The output single product demand quantity is used, for example, as the number of orders for the target product for each store. The output unit 70 may, for example, output the single product demand quantity of the target product to which the sales prospect quantity is added, in a different manner from the other target products (i.e., the target products to which the sales prospect quantity is not added).

The composition ratio calculator 20, the category sales number calculator 30, the expected sales number calculator 40, the prediction unit 50, the single product demand prediction unit 60, and the output unit 70 can be realized by a CPU (Central Processing Unit) of a computer that operates according to a program (composition ratio correction program). For example, the program is stored in the storage 10, and the CPU may read the program and operate as the composition ratio calculator 20, the category sales number calculator 30, the sales prospect quantity calculator 40, the prediction unit 50, the single product demand prediction unit 60 and the output unit 70, according to the program.

Each of the composition ratio calculation unit 20, the category sales number calculation unit 30, the expected sales number calculation unit 40, the prediction unit 50, the single product demand prediction unit 60, and the output unit 70 may be realized by specialized hardware.

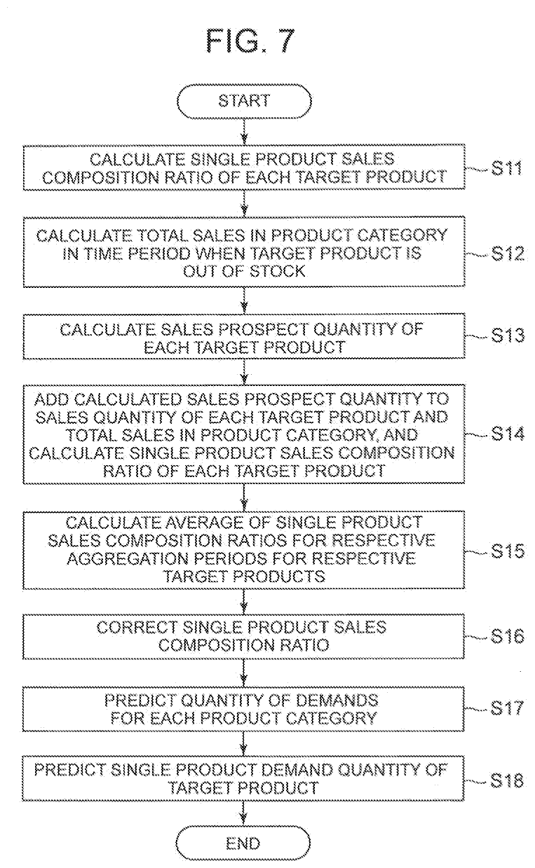

Next, operation of the composition ratio correction device 100 of this exemplary embodiment is described. FIG. 7 is a flowchart showing an example of operation of the composition ratio correction device of this exemplary embodiment.

The composition ratio calculation unit 20 calculates a single product sales composition ratio of each target product (step S11). The category sales quantity calculation unit 30 calculates total sales in the product category in the time period when the target product is out of stock (step S12). The sales prospect quantity calculation unit 40 calculates sales prospect quantity of each target product by multiplying the total sales in the product category during the out-of-stock time period by the single product sales composition ratio (step S13).

The composition ratio calculation unit 20 adds the calculated sales prospect quantity to the sales quantity of each target product and the total sales in the product category to which the product belongs, and calculates the ratio of the sales quantity of each target product to the calculated total sales as the single product sales composition ratio (step S14). Further, when the sales quantity is obtained over a plurality of aggregation periods, the composition ratio calculation unit 20 calculates an average of the single product sales composition ratios for respective aggregation periods for respective target products (step S15). The composition ratio calculation unit 20 corrects the original single product sales composition ratio with the calculated single product sales composition ratio (step S16).

The prediction unit 50 predicts the quantity of demands for each product category for each aggregation period (step S17). Then, the single product demand quantity prediction unit 60 predicts the single product demand quantity based on the result of the prediction of the quantity of demands for each product category and the corrected single product sales composition ratio to predict the single product demand quantity of the target product included in the product category (step S18).

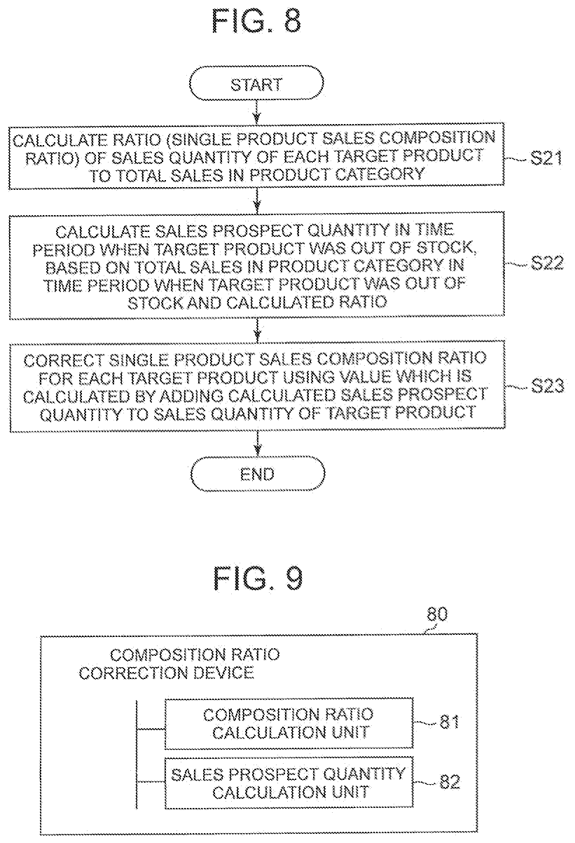

FIG. 8 is a flowchart showing another example of operation of the composition ratio correction device of this exemplary embodiment. The composition ratio calculation unit 20 calculates a single product sales composition ratio, which is a ratio of a sales quantity of each target product to total sales in the product category to which the target product belongs (step S21). The sales prospect quantity calculation unit 40 calculates a sales prospect quantity in the time period when the target product was out of stock, based on the total sales in the product category in the time period when the target product was out of stock and the calculated ratio (step S22). The composition ratio calculation unit 20 then corrects the single product sales composition ratio for each target product using a value which is calculated by adding the calculated sales prospect quantity to the sales quantity of the target product (step S23).

As described above, in this exemplary embodiment, the composition ratio calculation unit 20 calculates the single product sales composition ratio of each of the target product, and the sales prospect quantity calculation unit 40 calculates sales prospect quantity during the time period when the target product was out of stock, based on the total sales in the product category during the time period when the target product was out of stock and the calculated single product sales composition ratio. The composition ratio calculation unit 20 then corrects the single product sales composition ratio for each product by using the value which is calculated by adding the calculated sales prospect quantity to the sales quantity of the product to be predicted. Therefore, even if there is a shortage in the individual products to be predicted, the sales composition ratio assumed between similar products can be corrected appropriately.

That is, in this exemplary embodiment, the accuracy of prediction for individual products can be improved, because the total sales are assigned to each target product according to the ratio, based on the total sales in the product category. In this exemplary embodiment, the accuracy of prediction can be further improved for individual products because the ratio is corrected by taking into account the individual opportunity loss.

For example, in a method of placing an order by taking into account a stock quantity, the single product sales composition ratio is generally calculated without taking into account the out-of-stock. Therefore, it is preferable that the composition ratio correction device 100 of this exemplary embodiment is used for products that are not taken into consideration stocks (e.g., rice balls and noodles that have a short consuming term).

Hereinafter, a summary of the present invention will be described. FIG. 9 is a block diagram illustrating a summarized configuration of the composition ratio correction device according to the present invention. The composition ratio correction device 80 (for example, the composition ratio correction device 100) according to the present invention comprises a component ratio calculation unit 81 (for example, the component ratio calculation unit 20) which calculates a single product sales composition ratio that is a ratio of a sales quantity of each target product to total sales, in a predetermined aggregation period, in a product category to which the target product belongs; and a sales prospect quantity calculation unit 82 (for example, the sales prospect quantity calculation unit 40) which calculates a sales prospect quantity of the target product during a time period when the target product was out of stock, based on the total sales in the product category to which the target product belongs during the time period when the target product was out of stock and the calculated ratio.

The composition ratio calculation unit 81 corrects the single product sales composition ratio for each target product using a value which is calculated by adding the calculated sales prospect quantity to the sales quantity of the target product.

Such a configuration allows for appropriate correction of the sales composition ratio between similar products, even when a shortage occurs in each product to be predicted.

The composition ratio correction device 80 can include a category sales quantity calculation unit (for example, the category sales quantity calculation unit 30) which calculates, in the predetermined aggregation period, total sales in the product category to which the target product belongs during the time period when the target product was out of stock.

The composition ratio correction device 80 can include a single product demand quantity prediction unit (for example, the single product demand quantity prediction unit 60) which predicts a single product demand quantity of the target product included in the product category, based on the predicted result of the quantity of demands for each product category in the aggregation period and the corrected single product sales composition ratio. By predicting the single product sales composition ratio using the corrected single product sales composition ratio, it is possible to predict demand for a product with higher accuracy.

The component ratio calculation unit 81 may, as the target product (for example, a standard product) for calculating the single product sales composition ratio, a product that has achieved rankings equal to or higher than a predetermined ranking for the sales quantity in the past predetermined period over a predetermined number of times. In this perspective, for example, the accuracy of the prediction regarding the standard product can be improved by selecting the standard product, as the target product, with a small change of the quantity of demands.

The composition ratio correction device 80 can include a storage (for example, the storage 10) that stores past total sales in each product category on an hourly basis. Further, the category sales quantity calculation unit may obtain from the storage the total sales, corresponding to the time period when the target product was out of stock, in the product category to which the target product belongs, and calculates the obtained total sales for each aggregation period.

The component ratio calculation unit 81 may average one or more single product sales composition ratios and the corrected single product sales composition ratios in the past aggregate period.

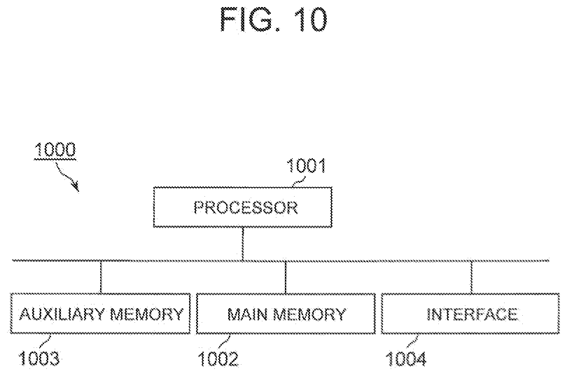

FIG. 10 is a schematic block diagram illustrating a configuration of a computer related to at least one exemplary embodiment. The computer 1000 has a processor 1001, a main memory 1002, an auxiliary memory 1003, and an interface 1004.

The above described composition ratio correction device is implemented in the computer 1000. The operation of each of the above described processing units is stored in an auxiliary memory 1003 as a program (the composition ratio correction program). The processor 1001 reads the program from the auxiliary memory 1003 and deploys the program to the main memory 1002, and implements the above described processing in accordance with the program.

In at least one exemplary embodiment, the auxiliary memory 1003 is an example of a non-transitory tangible medium. Other examples of non-transitory tangible media include a magnetic disk, an optical magnetic disk, a CD-ROM (Compact Disc Read only memory), a DVD-ROM (Read-only memory), a semiconductor memory, and the like. When the program is transmitted to the computer 1000 through a communication line, the computer 1000 receiving the transmission may deploy the program to the main memory 1002 and perform the above process.

The program may also be one for realizing some of the aforementioned functions. Furthermore, said program may be a so-called differential file (differential program), which realizes the aforementioned functions in combination with other programs already stored in the auxiliary memory 1003.

The aforementioned exemplary embodiments can be described as supplementary notes mentioned below, but are not limited to the following supplementary notes.

(Supplementary note 1) A composition ratio correction device comprising:

a component ratio calculation unit which calculates a single product sales composition ratio that is a ratio of a sales quantity of each target product to total sales, in a predetermined aggregation period, in a product category to which the target product belongs; and

a sales prospect quantity calculation unit which calculates a sales prospect quantity of the target product during a time period when the target product was out of stock, based on the total sales in the product category to which the target product belongs during the time period when the target product was out of stock and the calculated ratio,

wherein the component ratio calculation unit corrects the single product sales composition ratio for each target product using a value which is calculated by adding the calculated sales prospect quantity to the sales quantity of the target product.

(Supplementary note 2) The composition ratio correction device of Supplementary note 1, further comprising; a category sales quantity calculation unit which calculates, in the predetermined aggregation period, total sales in the product category to which the target product belongs during the time period when the target product was out of stock.

(Supplementary note 3) The composition ratio correction device of Supplementary note 1 or 2, further comprising; a single product demand quantity prediction unit which predicts a single product demand quantity of the target product included in the product category, based on the predicted result of the quantity of demands for each product category in the aggregation period and the corrected single product sales composition ratio.

(Supplementary note 4) The composition ratio correction device of any one of Supplementary notes 1 to 3, wherein the component ratio calculation unit selects, as the target product for calculating the single product sales composition ratio, a product that has achieved rankings equal to or higher than a predetermined ranking for the sales quantity in the past predetermined period over a predetermined number of times.

(Supplementary note 5) The composition ratio correction device of any one of Supplementary notes 1 to 4, further comprising a storage that stores past total sales in each product category on an hourly basis, wherein the category sales quantity calculation unit obtains from the storage the total sales, corresponding to the time period when the target product was out of stock, in the product category to which the target product belongs, and calculates the obtained total sales for each aggregation period.

(Supplementary note 6) The composition ratio correction device of any one of Supplementary notes 1 to 5, wherein the component ratio calculation unit averages one or more single product sales composition ratios and the corrected single product sales composition ratios in the past aggregate period.

(Supplementary note 7) The composition ratio correction device of any one of Supplementary notes 1 to 6, wherein the component ratio calculation unit calculates the ratio of the sales quantity on a daily basis, and calculates the single product sales composition ratio on the daily basis.

(Supplementary note 8) A composition ratio correction method comprising: calculating a single product sales composition ratio that is a ratio of a sales quantity of each target product to total sales in a product category to which the target product belongs; calculating a sales prospect quantity of the target product during a time period when the target product was out of stock, based on the total sales in the product category to which the target product belongs during the time period when the target product was out of stock and the calculated ratio; and

correcting the single product sales composition ratio for each target product using a value which is calculated by adding the calculated sales prospect quantity to the sales quantity of the target product.

(Supplementary note 9) The composition ratio correction method of Supplementary note 8, further comprising; calculating, in the predetermined aggregation period, total sales in the product category to which the target product belongs during the time period when the target product was out of stock.

(Supplementary note 10) A composition ratio correction program causing a computer to perform: a component ratio calculation process of calculating a single product sales composition ratio that is a ratio of a sales quantity of each target product to total sales, in a predetermined aggregation period, in a product category to which the target product belongs; and a sales prospect quantity calculation process of calculating a sales prospect quantity of the target product during a time period when the target product was out of stock, based on the total sales in the product category to which the target product belongs during the time period when the target product was out of stock and the calculated ratio, wherein in the component ratio calculation process, causing the computer to perform correcting the single product sales composition ratio for each target product using a value which is calculated by adding the calculated sales prospect quantity to the sales quantity of the target product.

(Supplementary note 11) The composition ratio correction program of Supplementary note 10, causing the computer to perform, a category sales quantity calculation process of calculating, in the predetermined aggregation period, total sales in the product category to which the target product belongs during the time period when the target product was out of stock.

While the present invention has been described with reference to the exemplary embodiments, the present invention is not limited to the aforementioned exemplary embodiments. Various changes understandable to those skilled in the art within the scope of the present invention can be made to the structures and details of the present invention.

This application claims priority based on Japanese Patent Application 2018-151251 filed on Aug. 10, 2018, and disclosures of which are incorporated herein in their entirety.

### REFERENCE SIGNS LIST

10 storage
20 composition ratio calculation unit
30 category sales quantity calculation unit
40 sales prospect quantity calculation unit
50 prediction unit
60 single product demand quantity prediction unit
70 output unit
100 composition ratio correction device

What is claimed is:

1. A composition ratio correction device comprising a hardware processor configured to execute a software code to:
calculate a single product sales composition ratio that is a ratio of a sales quantity of each target product to total sales, in a predetermined aggregation period, in a product category to which the target product belongs; and
calculate a sales prospect quantity of the target product during a time period when the target product was out of stock, based on the total sales in the product category to which the target product belongs during the time period when the target product was out of stock and the calculated ratio; and
correct the single product sales composition ratio for each target product using a value which is calculated by adding the calculated sales prospect quantity to the sales quantity of the target product.

2. The composition ratio correction device according to claim 1,
wherein the hardware processor is configured to execute a software code to calculate, in the predetermined aggregation period, total sales in the product category to which the target product belongs during the time period when the target product was out of stock.

3. The composition ratio correction device according to claim 1,
wherein the hardware processor is configured to execute a software code to predict a single product demand quantity of the target product included in the product category, based on the predicted result of the quantity of demands for each product category in the aggregation period and the corrected single product sales composition ratio.

4. The composition ratio correction device according to claim 1,
wherein the hardware processor is configured to execute a software code to select, as the target product for calculating the single product sales composition ratio, a product that has achieved rankings equal to or higher than a predetermined ranking for the sales quantity in the past predetermined period over a predetermined number of times.

5. The composition ratio correction device according to claim 2, a storage that stores past total sales in each product category on an hourly basis,
wherein the hardware processor is configured to execute a software code to obtain the total sales from a storage that stores past total sales in each product category on an hourly basis, corresponding to the time period when the target product was out of stock, in the product category to which the target product belongs, and calculate the obtained total sales for each aggregation period.

6. The composition ratio correction device according to claim 1,
wherein the hardware processor is configured to execute a software code to average one or more single product sales composition ratios and the corrected single product sales composition ratios in the past aggregate period.

7. The composition ratio correction device according to claim 1,
wherein the hardware processor is configured to execute a software code to calculate the ratio of the sales quantity on a daily basis, and calculate the single product sales composition ratio on the daily basis.

8. A composition ratio correction method comprising:
calculating a single product sales composition ratio that is a ratio of a sales quantity of each target product to total sales in a product category to which the target product belongs;
calculating a sales prospect quantity of the target product during a time period when the target product was out of stock, based on the total sales in the product category to which the target product belongs during the time period when the target product was out of stock and the calculated ratio; and
correcting the single product sales composition ratio for each target product using a value which is calculated by adding the calculated sales prospect quantity to the sales quantity of the target product.

9. The composition ratio correction method according to claim 8, further comprising
calculating, in the predetermined aggregation period, total sales in the product category to which the target product belongs during the time period when the target product was out of stock.

10. A non-transitory computer readable information recording medium storing a composition ratio correction program, when executed by a processor, that performs a method for:
calculating a single product sales composition ratio that is a ratio of a sales quantity of each target product to total sales, in a predetermined aggregation period, in a product category to which the target product belongs;
calculating a sales prospect quantity of the target product during a time period when the target product was out of stock, based on the total sales in the product category to which the target product belongs during the time period when the target product was out of stock and the calculated ratio; and
correcting the single product sales composition ratio for each target product using a value which is calculated by adding the calculated sales prospect quantity to the sales quantity of the target product.

11. The non-transitory computer readable information recording medium according to claim 10,
further comprising calculating, in the predetermined aggregation period, total sales in the product category to which the target product belongs during the time period when the target product was out of stock.
